(19) United States
(12) Patent Application Publication
(10) Pub. No.: US 2020/0039409 A1
(43) Pub. Date: Feb. 6, 2020

(54) POLYMERIC TRAY TABLE ARM AND METHODS OF MAKING THE SAME

(71) Applicant: SABIC GLOBAL TECHNOLOGIES B.V., Bergen op Zoom (NL)

(72) Inventors: Daniel Caleb BROOKS, Selkirk, NY (US); Anil TIWARI, Bangalore (IN); Harindranath SHARMA, Bangalore (IN); Rajkumar KARTHIKEYAN, Bangalore (IN); Peter James ZUBER, Pittsfield, MA (US); Poovana THEETHIRA KUSHALAPPA, Bangalore (IN); Rahul Ravindra SAGARE, Selkirk, NY (US); Pavan PURANIK, Bangalore (IN)

(21) Appl. No.: 16/498,759

(22) PCT Filed: Mar. 30, 2018
(86) PCT No.: PCT/US2018/025315

§ 371 Date: Sep. 27, 2019

Related U.S. Application Data
(60) Provisional application No. 62/479,369, filed on Mar. 31, 2017.

(51) Int. Cl. B60N 3/00; B64D 11/06

(52) U.S. Cl. CPC B60N 3/004; B64D 11/0638

(57) ABSTRACT

A support arm (12) includes: a body portion disposed between a seat end (20) and a table end (18); wherein the support arm (12) comprises a composition comprising a polymeric material, a metallic material, a thermoset material, an elastomeric material, or a combination comprising at least one of the foregoing, and a filler; and wherein the seat end (20) comprises a snap fit connector (14) configured to engage with an opening (22) in the seat end (20).

### BACKGROUND

Tray table arms are employed across the transportation segment in transportation vessels such as airplanes, trains, helicopters, and buses. For example, airplanes are equipped with tray tables for use by passengers during flight. Tray tables are typically stowed in the seatback of most passenger seats in a non-operative position and are lowered into an operative position during flight. Tray tables are customarily connected to a set of support arms (also referred to as tray table arms) which pivot downwardly from the seatback immediately forward of the passenger to the operative position. The support arms are commonly attached to the sides of the seat frame so as not to interfere with the living space of either passenger, and to support the tray table about each of its ends. Likewise, the tray table can be supported by a single support arm.

Tray table arms are generally made from isotropic metals such as aluminum due to their excellent isotropic mechanical properties as well as due to their lower weights as compared to metals such as steel. However, metallic arms are machined and subject to other secondary operations, which add to manufacturing costs and time.

In mass transportation vessels, tray table arms are generally mounted to adaptors between seating with arms affixed to the adaptors using various hardware such as fasteners. The hardware adds weight and complexity to the assembly. It can also be time consuming to replace in case of damage or failure to the tray table arm. In some designs, the hardware placement can sacrifice geometry in load bearing regions of the arm.

Weight reduction in aerospace components offers significant benefits in terms of cost reduction arising from fuel savings and/or increased range for the transportation vessel. There accordingly remains a need in the art for a lighter weight support arm that does not experience premature failure and can offer efficiencies in manufacturing cost and time.

### SUMMARY

Disclosed herein are support arms, tray table arms and assemblies, articles comprising the same, and methods of making the same. The support arms disclosed herein include a snap fit connector.

A support arm includes: a body portion disposed between a seat end and a table end; wherein the support arm comprises a composition comprising a polymeric material, a metallic material, a thermoset material, an elastomeric material, or a combination comprising at least one of the foregoing, and a filler; and wherein the seat end comprises a snap fit connector configured to engage with an opening in the seat end.

A tray table includes: a support arm comprising a body portion disposed between a seat end and a table end, wherein the support arm comprises a composition comprising a polymeric material, a metallic material, a thermoset material, an elastomeric material, or a combination comprising at least one of the foregoing and a filler, and wherein the seat end comprises a snap fit connector configured to engage with an opening in the seat end; a torque rod; a pivot block; a stopper pin; a table; and a means for keeping the tray table in the operable position.

The above described and other features are exemplified by the following figures and detailed description.

### BRIEF DESCRIPTION OF THE DRAWINGS

Refer now to the figures, which are exemplary embodiments, and wherein like elements are numbered alike and which are presented for the purposes of illustrating the exemplary embodiments disclosed herein and not for the purposes of limiting the same.

FIG. 1 is an illustration of a tray table.

FIG. 2A is a depiction of a support arm.

FIG. 2B is a close up view of the table end of the support arm of FIG. 2A.

FIG. 2C is a close up view of the seat end of the support arm of FIG. 2A.

FIG. 2D is a view of the seat end, body portion and table end of the support arm of FIG. 2A.

FIG. 3A is an isometric view of the support arm.

FIG. 3B is an isometric view of the seat end of the support arm of FIG. 3A.

FIG. 3C is an isometric view of the seat end of the support arm of FIG. 3A.

FIG. 4A is an isometric view of the support arm.

FIG. 4B is an exploded view of the support arm of FIG. 4A.

FIG. 5A is an isometric view of the seat end of the support arm of FIG. 3A.

FIG. 5B is an isometric view of the seat end of the support arm of FIG. 3A.

FIG. 6 is an isometric view of a snap fit connector.

FIGS. 7A-7E are isometric views of various designs of the snap fit connector of FIG. 6.

FIG. 8 is an isometric view of the support arm.

FIG. 9 is an isometric view of the support arm.

FIG. 10A is a two-sided view of the support arm with ribs.

FIG. 10B is a two-sided view of the support arm with ribs.

FIG. 11A is an isometric view of the support arm.

FIG. 11B is an isometric view of the table end of the support arm of FIG. 11A.

FIG. 11C is a front view of an insert with a 90 degree angle.

FIG. 11D is a front view of an insert with a 45 degree angle.

FIG. 12 is an isometric view of a support arm with a snap fit connector attached.

FIG. 13 is an isometric view of a snap fit connector with diagonal snaps.

FIG. 14A is an isometric view of a support arm and snap fit connector with an assembly rod.

FIG. 14B is a front view of the support arm and snap fit connector of FIG. 14A.

FIG. 14C is a front view of the seat end of the support arm with a snap fit connector attached.

FIG. 15 is an isometric view of the support arm tested in Example 1.

FIG. 16A is an isometric view of a support arm and snap fit connector.

FIGS. 16B and 16C are side views of the support arm and snap fit connector of FIG. 16A.

FIG. 17A is an isometric view of a support arm.

FIG. 17B is a sectional view of the support arm of FIG. 17A taken along line A-A.

FIGS. 18A to 18D are isometric views of a support arm and snap fit connector.

FIG. 19A is an isometric view of a support arm and snap fit connector.

FIG. 19B is an isometric view of the snap fit connector of FIG. 19A.

FIGS. 20A to 20C are isometric views of a support arm.

FIG. 21 is an isometric view of a support arm.

FIG. 22 is a graphical representation of the Samples tested versus the forces withstood before breakage of the support arm having the design in FIG. 21.

### DETAILED DESCRIPTION

Disclosed herein are support arms, also referred to herein as hinged arm, tray table arm, and tray table assemblies. The support arm can include a body portion disposed between a seat end and a table end. The support arm can be made from a polymeric material, a metallic material, a thermoset material, or a combination comprising at least one of the foregoing and a filler. A snap fit connector can engage with an opening in the seat end of the support arm. The seat end can include snap fit connector engagement portions that are configured to engage with corresponding engagement portions on the snap fit connector. The support arm can be formed by a variety of methods, including, but not limited to, injection molding, and can be used to support food tray tables in aerospace applications. The snap fit connector can be used to assemble the food table assembly to the rest of the seat assembly. The snap fit connector can provide an advantage over existing systems with the elimination of various assembly mechanisms such as bolts and screws. The snap fit connector can also provide improved structural performance of the support arm with addition of flanges and ribs that can be present on a curved section of the support arm which can improve load bearing capacity.

Support arms for tray tables on airplanes are typically made of aluminum due to its excellent mechanical properties. Attempts to reduce the weight of tray table support arms in order to achieve a cost reduction arising from fuel savings has resulted in attempts to utilize lighter weight polymeric materials in place of the aluminum. Towards this, there have been attempts to replace aerospace grade aluminum with lighter polymeric materials. However, there have been problems with respect to the structural integrity and premature failure of such polymeric support arms, where premature failure frequently occurs in regions of high stress that the polymeric material cannot accommodate. Desirable location and orientation of an insert receiving a set screw in the support arm can also be achieved with the support arm disclosed herein. Optimal orientation can provide the best load distribution to the support arm at the table end of the support arm, which means that lighter weight polymeric materials can be utilized without suffering from the structural integrity and premature failure from which other polymeric supports have suffered.

The support arm can include opening with a gear tooth configured to engage with a corresponding recess in the snap fit connector. The snap fit connector can include snap features (e.g., snaps) on a top portion and a bottom portion of the snap fit connector. The snap fit connector can include snap features on a left portion and a right portion in the top portion. The snap fit connector can include snap features on the bottom portion of the snap fit connector. Snap features located on the top portion and the bottom portion of the snap fit connector can be located on opposite sides of the snap fit connector or can be located on the same side of the snap fit connector. The snap features can have a width that is half of the overall width of the snap-fit connector. Half a width of the snap-fit connector can include a solid portion configured to transfer a load applied to the body portion of the support arm.

The snap fit connector can optionally include disassembly openings on each of the snap features configured to accept a tool to effect disassembly of the snap fit connector from the body portion.

The body portion of the support arm can include flanges dispersed along a length of the body portion. The flanges are located along outside edges of the body portion. The body portion of the support arm can include a curved portion near the table end of the support arm. Ribs can be dispersed in the curved portion. The ribs can be diagonal ribs, vertical ribs, or cross-sectional ribs, or a combination comprising at least one of the foregoing.

The table end can include an insert located in a high stress region of the support arm. A set screw (e.g., a grub screw) can be located in the insert. The set screw can assist with movement of the tray table from resting to operable positions. The set screw can be disposed at an angle less of than 90 degrees with respect to a tray table attached to the support arm, for example, the angle can be less than or equal to 45 degrees.

A tray table can include a support arm that includes a body portion disposed between a seat end and a table end. The support arm can be made from a composition comprising a polymeric material a metallic material, a thermoset material, an elastomeric material, or a combination comprising at least one of the foregoing and a filler. The tray table can include a snap fit connector that is configured to engage with an opening in the seat end of the support arm. The tray table can include a torque rod, a pivot block, a stopper pin, a table; and a means for keeping the tray table in the operable position. The means for operable position can include a set screw disposed in an insert at the table end of the support arm. The set screw can prevent the further rotational motion of the stopper pin when the tray table is in the operable position. The set screw can be disposed at an angle of less than 90 degrees with respect to a tray table attached to the support arm, for example, the angle can be than or equal to 45 degrees.

The filler present in the composition of the support arm can be present in an amount of less than or equal to 80 weight % (wt %), based on the total weight of the composition of the support arm, for example, less than or equal to 40 wt %, for example, less than or equal to 20 wt %. A method of attaching a snap fit connector to a support arm can include snap fitting an assembly rod into a snap fit connector; and snap fitting the snap fit connector to support arm as described herein.

The support arm and/or the snap fit connector can comprise a polymeric material such as a polymeric material, or a combination of polymeric and thermoset materials. The polymeric material can comprise a polycarbonate, a polyester (such as poly(ethylene terephthalate), poly(butylene terephthalate), and poly(lactic acid)), a polyamide (such as aliphatic polyamides including nylon 6, semi-aromatic polyphthalamides, and aromatic polyamides), a polyimide (such as polyetherimide), a polyketone (such as poly(ether ether ketone) (PEEK), poly(ether ketone), and poly(aryl ether ketone)), a polysulfide (such as poly(phenylene sulfide)), a polysulfone (such as poly(ether sulfone)), a polyacrylate (such as poly(methyl methacrylate)), a polyacetal (such as poly(oxymethylene)), a polyacetate (such as poly(vinyl acetate)), a fluoro plastic (such as polytetrafluoroethylene), a chloro plastic (such as poly(vinyl chloride) and poly(vinylidene chloride)), a polyethylene (such as high density polyethylene, low density polyethylene, and ultra-high molecular weight polyethylene), a polyurethane, polypropylene, an acrylonitrile butadiene styrene copolymer, a styrene acrylonitrile copolymer, polyphenylene, polyvinyl alcohol, polystyrene, polycaprolactone, polybutylene, polybutadiene, a copolymer comprising at least one or more of the foregoing, or a blend comprising at least one or more of the foregoing.

The support arm can include a polymeric material that is polycarbonate, polyester, a polyamide, a polyimide, a polyketone, a polysulfide, a polysulfone, a polyacrylate, a polyacetal, a polyacetate, a fluoro plastic, a chloro plastic, a polyethylene, a polyurethane, polypropylene, an acrylonitrile butadiene styrene copolymer, a styrene acrylonitrile copolymer, polyphenylene, polyvinyl alcohol, polystyrene, polycaprolactone, polybutylene, polybutadiene, a copolymer comprising at least one or more of the foregoing, or a blend comprising at least one or more of the foregoing, for example, polyetherimide. The snap fit connector can be made from a composition that includes a polymeric material.

For example, the polymeric material can comprise a polycarbonate/ABS blend (CYCOLOY™ resins commercially available from SABIC's Innovative Plastics business), a copolycarbonate-polyester, acrylic-styrene-acrylonitrile (ASA) (GELOY™ resins commercially available from SABIC's Innovative Plastics business), a blend of polyphenylene ether/polyamide (NORYL GTX™ resins from SABIC's Innovative Plastics business), a blend of polycarbonate/polyethylene terephthalate (PET)/polybutylene terephthalate (PBT), polybutylene terephthalate and impact modifier (XENOY™ resins commercially available from SABIC's Innovative Plastics business), polycarbonate (LEXAN™ and LEXAN™ EXL resins commercially available from SABIC's Innovative Plastics business), poly(methyl)meth acrylate (PMMA) capped polycarbonate, polyetherimide (ULTEM™ polyetherimide resin (e.g., EC006PXQ™ and/or EC008PXQ™) or SILTEM™, both commercially available SABIC's Innovative Plastics business). The support arm can comprise a filled polymeric material. The snap fit connector can comprise an unfilled polymeric material.

The support arm can comprise a filler. The support arm can comprise a mixture of fillers. Non-limiting examples of fillers include silica powder, such as fused silica, crystalline silica, natural silica sand, and various silane-coated silicas; boron-nitride powder and boron-silicate powders; alumina and magnesium oxide (or magnesia); wollastonite including surface-treated wollastonite; calcium sulfate (as, for example, its anhydride, dihydrate or trihydrate); calcium carbonates including chalk, limestone, marble and synthetic, precipitated calcium carbonates, generally in the form of a ground particulate which often comprises 98+% CaCO₃ with the remainder being other inorganics such as magnesium carbonate, iron oxide and alumino-silicates; surface-treated calcium carbonates; talc, including fibrous, modular, needle shaped, and lamellar talcs; glass spheres, both hollow and solid, and surface-treated glass spheres typically having coupling agents such as silane coupling agents and/or containing a conductive coating; kaolin, including hard, soft, calcined kaolin, and kaolin comprising various coatings known in the art to facilitate the dispersion in and compatibility with the thermoset resin; mica, including metallized mica and mica surface treated with aminosilanes or acryloylsilanes coatings to impart good physicals to compounded blends; feldspar and nepheline syenite; silicate spheres; flue dust; cenospheres; fillite; aluminosilicate (armospheres), including silanized and metallized aluminosilicate; quartz; quartzite; perlite; tripoli; diatomaceous earth; silicon carbide; molybdenum sulfide; zinc sulfide; aluminum silicate (mullite); synthetic calcium silicate; zirconium silicate; barium titanate; barium ferrite; barium sulfate and heavy spar; particulate or fibrous aluminum, bronze, zinc, copper and nickel; carbon black, including conductive carbon black; and graphite, such as graphite powder.

The filler can comprise a filler having an aspect ratio greater than 1. Such fillers can exist in the form of flakes, whiskers, fibers, needles, rods, tubes, strands, elongated platelets, lamellar platelets, ellipsoids, micro fibers, nanofibers, nanotubes, elongated fullerenes, and the like. Where such fillers exist in aggregate form, an aggregate having an aspect ratio greater than 1 will also suffice. Examples of such fillers well known in the art include those described in “Plastic Additives Handbook, 5th Edition” Hans Zweifel, Ed, Carl Hanser Verlag Publishers, Munich, 2001.

Non-limiting examples of flakes having an aspect ratio greater than 1, for example, greater than 2, include glass flakes, flaked silicon carbide, aluminum diboride, aluminum flakes, and steel flakes. Non-limiting examples of fibrous fillers include processed mineral fibers such as those derived from blends comprising at least one of aluminum silicates, aluminum oxides, magnesium oxides, calcium sulfate hemihydrate, boron fibers, ceramic fibers such as silicon carbide, and fibers from mixed oxides of aluminum, boron, and silicon sold under the trade name NEXTELT by 3M Co., St. Paul, Minn., USA; and natural fibers including wood flour, cellulose, cotton, sisal, jute, starch, cork flour, lignin, ground nut shells, corn, rice grain husks, cloth, hemp cloth, felt, and natural cellulosic fabrics such as Kraft paper, cotton paper, and glass fiber containing paper. Synthetic reinforcing fibers can be used provided the glass transition temperature of the synthetic fiber is greater than that of the polymeric material. Suitable synthetic fibers include polyester fibers such as poly(ethylene terephthalate) and poly(butylene terephthalate), poly(vinyl alcohol) fibers, polyarylates, polyethylene, aromatic polyamide fibers, polybenzimidazole fibers, poly(phenylene sulfide) fibers, poly(ether ether ketone) fibers, polytetrafluoroethylene fibers, acrylic resin fibers, high tenacity fibers with high thermal stability including aromatic polyamides, polyaramid fibers such as Kevlar (product of Du Pont), polyimide fibers such as polyimide 2080 and PBZ fiber (both products of Dow Chemical Company) and polyetherimide fibers; poly(ether ether ketone) fibers, polybenzoxazole fibers, and the like. Fibrous fillers such as basalt fibers, including textile glass fibers and quartz are also considered.

The filler can comprise glass fibers. Useful glass fibers can be formed from any type of fiberizable glass composition known to those skilled in the art, and include those prepared from fiberizable glass compositions commonly known as “E-glass,” “A-glass,” “C-glass,” “D-glass,” “R-glass,” “S-glass,” as well as E-glass derivatives that are fluorine-free and/or boron-free. Such compositions and methods of making glass filaments therefrom are well known to those skilled in the art and a more detailed description is not necessary.

The filler can comprise a carbon fiber. The carbon fibers can have an average diameter of 3.5 nanometers to 5 micrometers, specifically 4 to 100 nanometers, more specifically 5 to 10 nanometers. The carbon fibers can be vapor-grown carbon fibers. The carbon fiber can comprise carbon nanotubes. The carbon nanotubes can have a length to diameter ratio of up to 132,000,000:1. The carbon nanotubes can comprise single walled nanotubes and/or multi-walled nanotubes.

The filler can be used with various coatings, including, for example, metallic coatings and silane coating.

In general, the amount of optional fibrous filler present in the polymeric composition can be up to 80 weight percent (wt %) (e.g., greater than 0 to 80 wt %) based on the total weight of the composition, for example 10 to 80 wt %, and more specifically, 20 to 40 wt % thereof.

The support arm can have flame retardant properties such that it is compliant with the Federal Aviation Regulation (FAR). The support arm can meet one or more of the FAR requirements for low heat low smoke density, and low toxic combustion by-products. Specifically, the support arm can have one or more of a peak heat release of less than 65 kW/m², as measured by FAR 25.853 (OSU test); a total heat release at 2 minutes of less than or equal to 65 kW*min/m² as measured by FAR 25.853 (OSU test); and an NBS optical smoke density of less than 200 when measured at 4 minutes, based on ASTM E-662 (FAR/JAR 25.853).

The support arm and/or snap fit connector can comprise a flame retardant additive. Useful flame retardants include organic compounds that include phosphorus, bromine, or chlorine. Non-brominated and non-chlorinated phosphorus-containing flame retardants can be preferred in certain applications for regulatory reasons, for example organic phosphates and organic compounds containing phosphorus-nitrogen bonds.

Flame retardant aromatic phosphates include triphenyl phosphate, tricresyl phosphate, isopropylated triphenyl phosphate, phenyl bis(dodecyl) phosphate, phenyl bis(neopentyl) phosphate, phenyl bis(3,5,5′-trimethylhexyl) phosphate, ethyl diphenyl phosphate, 2-ethylhexyl di(p-tolyl) phosphate, bis(2-ethylhexyl) p-tolyl phosphate, tritolyl phosphate, bis(2-ethylhexyl) phenyl phosphate, tri(nonylphenyl) phosphate, bis(dodecyl) p-tolyl phosphate, dibutyl phenyl phosphate, 2-chloroethyl diphenyl phosphate, p-tolyl bis(2,5,5′-trimethylhexyl) phosphate, and 2-ethylhexyl diphenyl phosphate. Di- or polyfunctional aromatic phosphorus-containing compounds are also useful, for example resorcinol tetraphenyl diphosphate (RDP), the bis(diphenyl) phosphate of hydroquinone and the bis(diphenyl) phosphate of bisphenol A, respectively, and their oligomeric and polymeric counterparts. Flame retardant compounds containing phosphorus-nitrogen bonds include phosphonitrilic chloride, phosphorus ester amides, phosphoric acid amides, phosphonic acid amides, phosphinic acid amides, and tris(aziridinyl) phosphine oxide. When used, phosphorus-containing flame retardants are present in amounts of 0.1 to 30 parts by weight, more specifically 1 to 20 parts by weight, based on 100 parts by weight of the total composition, excluding any filler.

Halogenated materials can also be used as flame retardants, for example bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; and 2,2-bis-(3,5-dichloro-4-hydroxyphenyl)-propane 2,2 bis-(3-bromo-4-hydroxyphenyl)-propane. Other halogenated materials include 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, as well as oligomeric and polymeric halogenated aromatic compounds, such as a copolycarbonate of bisphenol A and tetrabromobisphenol A and a carbonate precursor, e.g., phosgene. Metal synergists, e.g., antimony oxide, can also be used with the flame retardant. When present, halogen containing flame retardants are present in amounts of 1 to 25 parts by weight, more specifically 2 to 20 parts by weight, based on 100 parts by weight of the total composition, excluding any filler.

Alternatively, the polymeric composition can be essentially free of chlorine and bromine. “Essentially free of chlorine and bromine” is defined as having a bromine or chlorine content of less than or equal to 100 parts per million by weight (ppm), less than or equal to 75 ppm, or less than or equal to 50 ppm, based on the total parts by weight of the composition, excluding any filler.

Inorganic flame retardants can also be used, for example salts of C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate; salts such as Na₂CO₃, K₂CO₃, MgCO₃, CaCO₃, and BaCO₃, or fluoro-anion complexes such as Li₃AlF₆, BaSiF₆, KBF₄, K₃AlF₆, KAlF₄, K₂SiF₆, or Na₃AlF₆. When present, inorganic flame retardant salts are present in amounts of 0.01 to 10 parts by weight, more specifically 0.02 to 1 parts by weight, based on 100 parts by weight of the total composition, excluding any filler.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

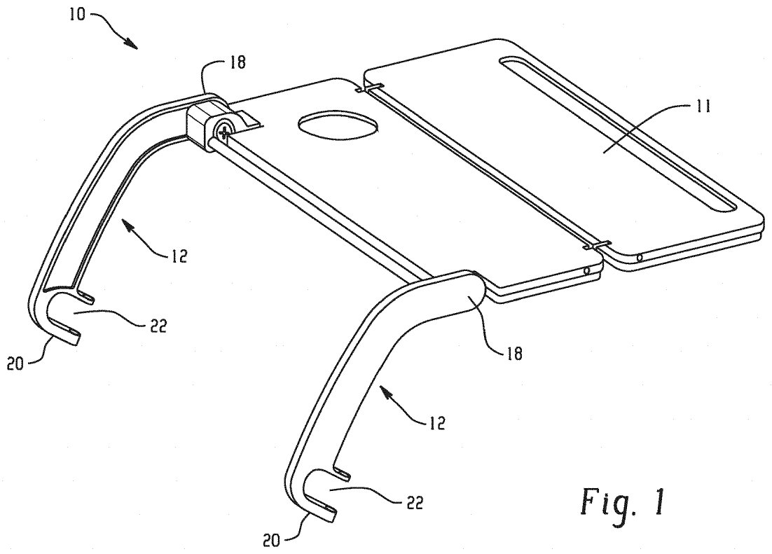

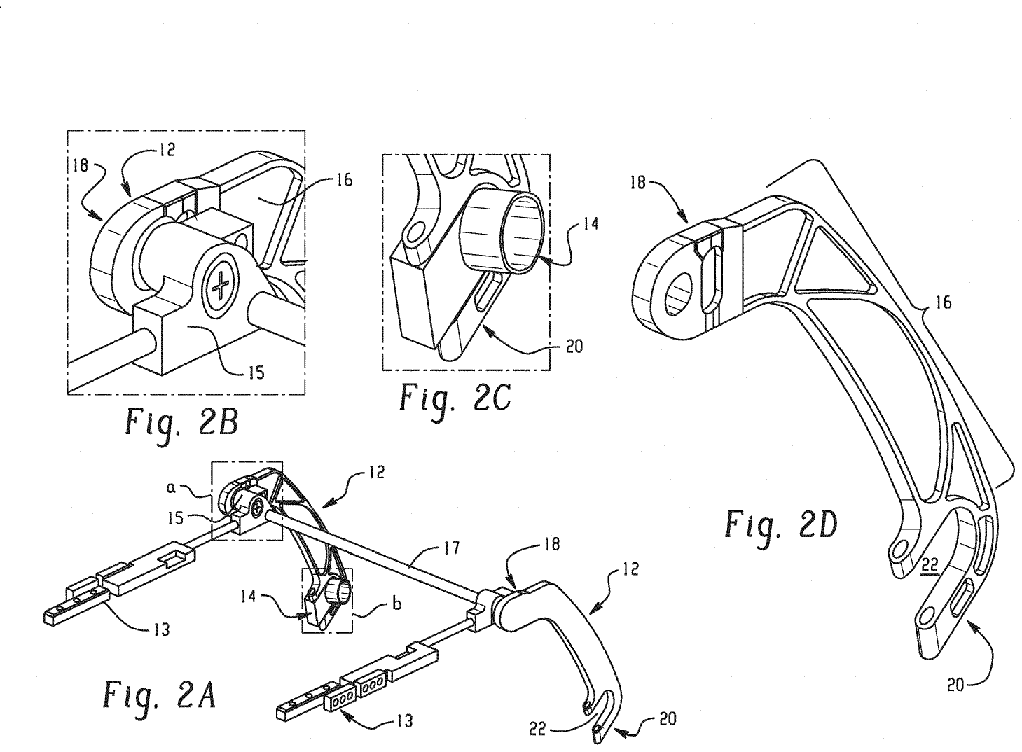

FIG. 1 shows a picture of a tray table assembly 10 with support arms 12 attached thereto. An opening 22 can be seen in each support arm 12 at a seat end 20. A tray table 11 extends from a table end 18 of the support arm 12. FIGS. 2A-2D show the support arm 12 in more detail as well as a snap fit connector 14. In FIG. 2A, the support arm 12 with the snap fit connector 14 inserted in the opening 22 at the seat end 20 is shown. Also shown in FIG. 2A is a frame 13 of the tray table 11 that supports and holds the tray table 11 in place. FIG. 2B is an exploded view of the boxed section “a” in FIG. 2A. In FIG. 2B, a pivot block 15 configured to accept a rod torque 17 of the frame 13 of the tray table 11 is shown. The pivot block 15 is connected to a body portion 16 of the support arm 12. The tray table 11 is connected to the frame 13. FIG. 2C is an exploded view of the boxed section “b” in FIG. 2A showing the seat end 20 of the support arm 12. In FIG. 2C, a snap fit connector 14 is shown attached to the support 12 at the seat end 20 of the support arm 12. The snap fit connector 14 was placed in the opening 22 of the support arm 12 and snap fit into place with snap fit projections on the snap fit connector 14 and a corresponding recess in the opening 20 of the support arm 12. FIG. 2D shows the opening 22 located in the seat end 20 of the support arm 12. The snap fit connector 14 is configured to engage with recesses located in the opening 22. A body 16 of the support 12 is also shown in FIG. 2D and will be described in further detail herein.

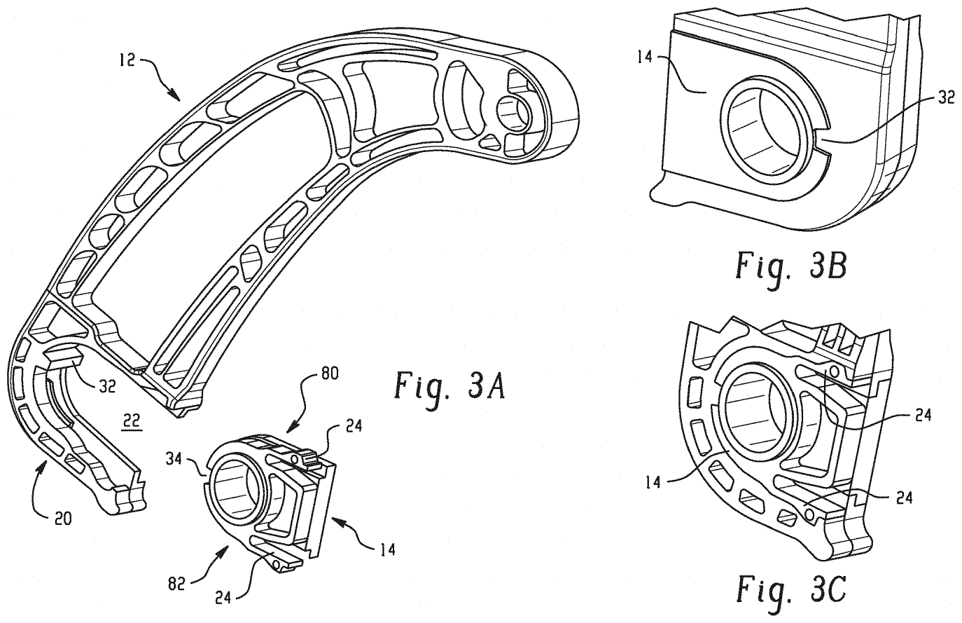

Turning now to FIGS. 3A-3C, the support arm 12 and snap fit connector 14 are shown in more detail. FIGS. 3A, 3B, and 3C show the snap fit connector 14 at the seat end 20 of the support arm 12. As shown in FIG. 3A, the opening 22 in the support arm 20 contains a gear tooth 32 configured to accept a corresponding recess 34 on the snap fit connector 14. The snap fit connector 14 can be snapped into the opening 22 on the seat end 20 of the support arm 12 with snaps 24 located on a top portion 80 and a bottom portion 82 of the snap fit connector 14. The use of the snap fit connector 14 can eliminate the use of various assembly mechanisms such as bolts, thereby eliminating holes in the support arm 12 for accommodate the assembly mechanism and thus, eliminating a potential weak spot in the support arm 12. FIG. 3B shows an external view of the support arm 12 and snap fit connector 14 attached to one another, while FIG. 3C shows an internal view (e.g., passenger facing view) of the support arm 12 and snap fit connector 14 attached to one another.

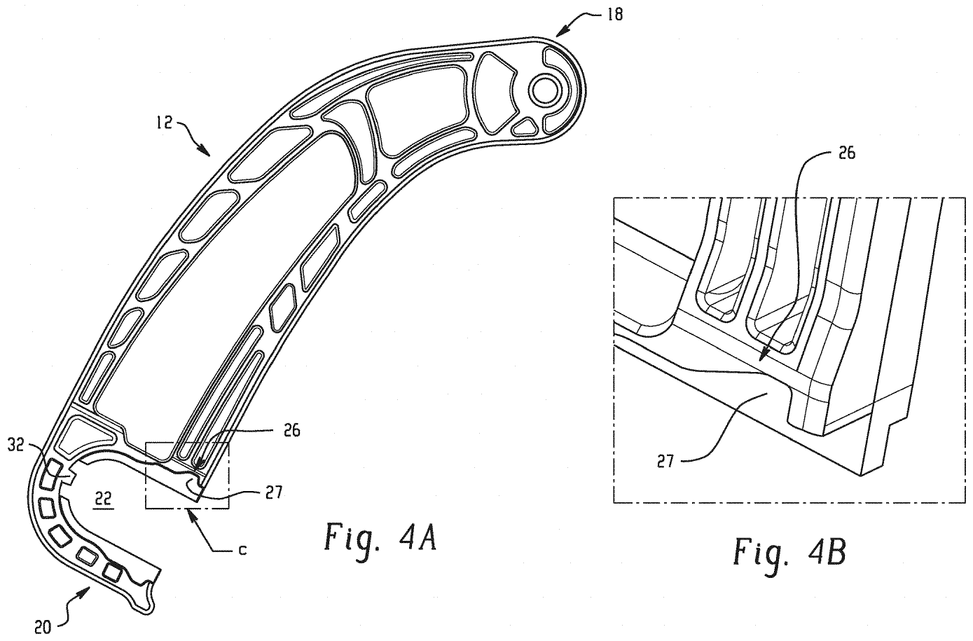

FIG. 4A shows the support arm 12 with the opening 22 at the seat end 20. In FIG. 4A, the gear tooth 32 configured to engage with the recess 24 of the snap fit connector 14 is shown. FIG. 4B, which is an exploded view of boxed section “c” in FIG. 4A shows the section of the support arm 12 directly above the opening 22 in more detail. As shown in FIG. 4B, a section 26 can have an indentation 27, which can have an increased height as compared to the rest of the section 26. The increased height in the indentation 27 can be configured to accommodate the snap 24 located at the top portion 80 of the snap fit connector 14 (see FIG. 3A).

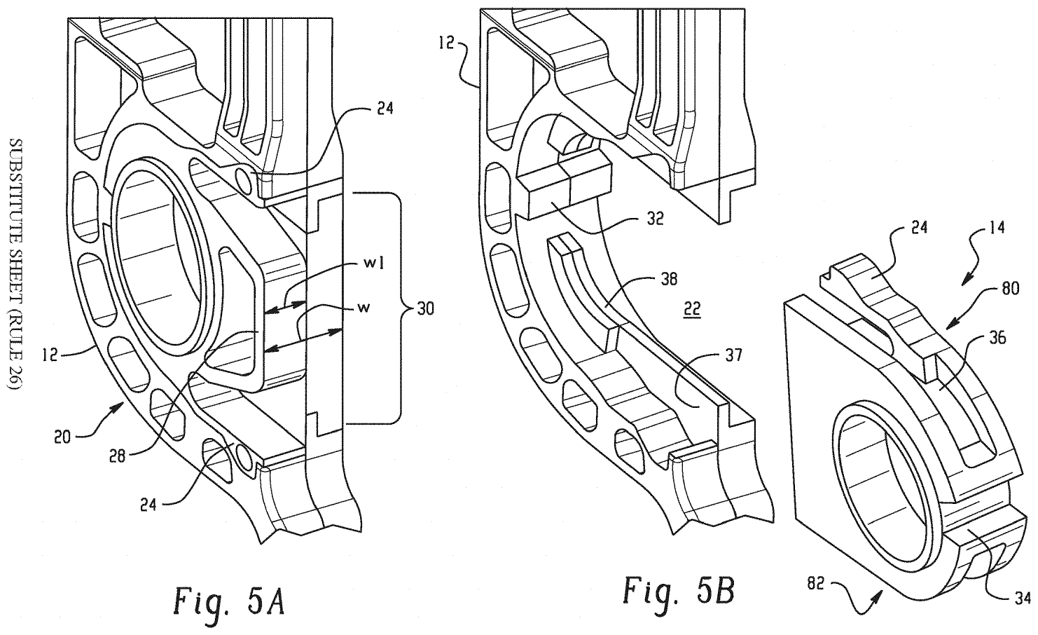

Turning now to FIGS. 5A and 5B, views of the support arm 12 and the snap fit connector 14 before and after assembly are shown. In FIG. 5A, the snap fit connector 14 is assembled to the support arm 12. In FIG. 5A, the snap fit connector 14 has been fit into the opening 22 of the support arm 12 at the seat end 20. In FIG. 5B, the gear tooth feature 32 in the opening 22 of the support arm 12 can engage with the recess 34 in the snap fit connector 14. The snap fit connector has snaps 24 located at a top portion 80 and a bottom portion 82 of the snap fit connector 14. As shown in FIG. 5A, the snap fit connector has a width, w. A width of the snaps 24, w 1, can be equivalent to half the overall width, w, of the snap fit connector 14 in a snap portion 28. The portion of the snap fit connector not containing the snaps can include a solid portion 30. The solid portion 30 can be configured to transfer a load experienced by the support arm 12 without straining or stressing or breakage of the snaps 24. The opening 22 in the support arm 12 can contain a protrusion 38 extending from the support arm 12 configured to engage with a corresponding recess 36 on the snap fit connector 14 to arrest axial relative motion therebetween. The protrusion 38 can extend vertically upward from a base portion 37 of the opening support arm 22.

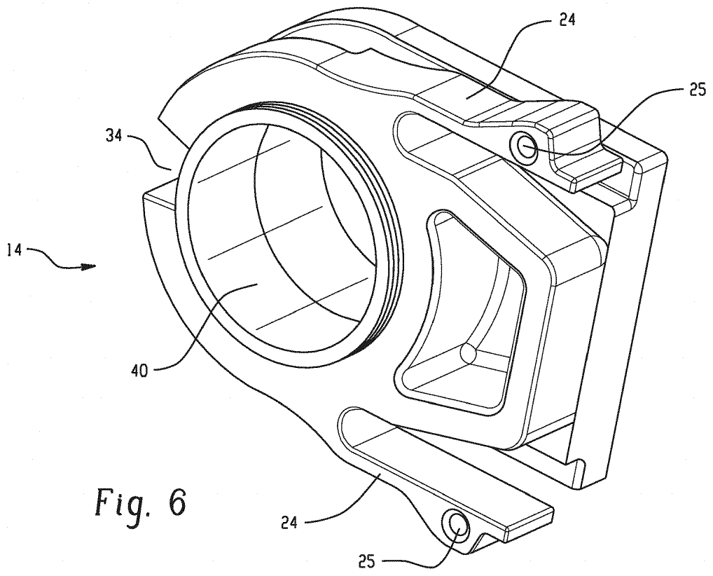

FIG. 6 shows the snap fit connector 14 with holes 25 located at an opposite end of the snap fit connector 14 as that containing the recess 34. The holes 25 can be configured to assist with disassembly of the snap fit connector 14 from the support arm 12. For example, a tool, e.g., tongs, pliers, etc. can be inserted in the holes 25, the tool can be pressed to push the snaps 24 toward one another. At this point the tool can be pulled to disassemble the support arm 12 from the snap fit connector 14. Disassembly of the support arm 12 from the snap fit connector 14 can occur without damage to either component. Such damage less assembly and disassembly can allow for reuse of the snap fit connectors or assembly of a new snap fit connector without having to replace the entire support arm.

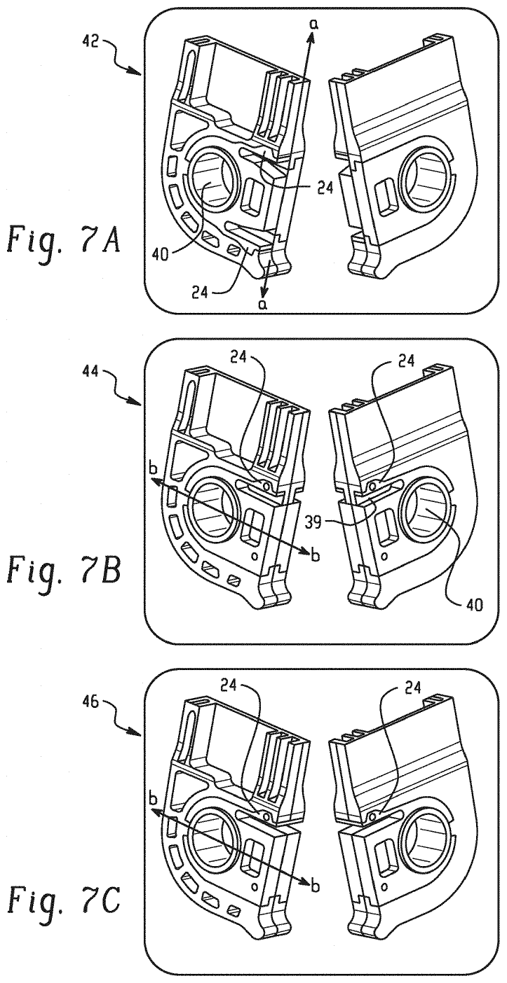

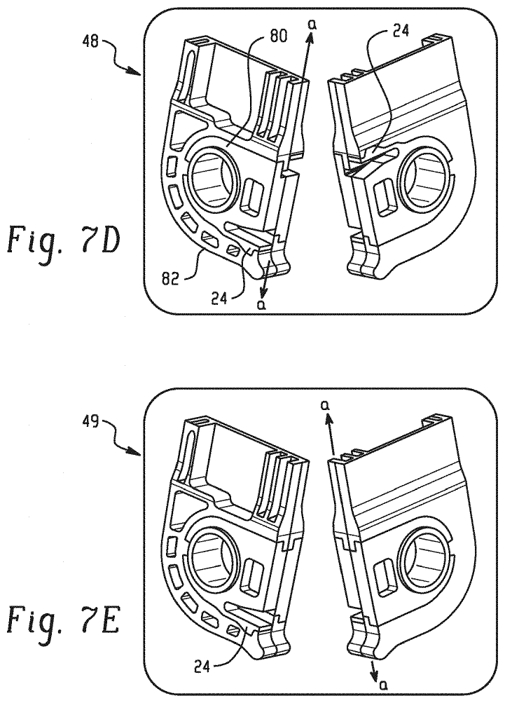

FIGS. 7A through 7E show various configurations of the snap fit connector 42, 44, 46, 48, 49, respectively. For example, in FIG. 7A the snaps 24 are located along the same plane a-a along the length, e.g., at a top and bottom of the snap fit connector on the same side. In FIG. 7B, the snaps 24 are located along the same plane b-b across the length of the snap fit connector 24, but are discontinuous, meaning that a spacer 39 is disposed between each snap 24. FIG. 7C shows the snaps 24 as being continuous on the same plane b-b across the length, i.e., without a spacer 39 therebetween as in FIG. 7B. FIG. 7D shows the snaps 24 being adjacent at a top portion 80 and a bottom portion 82 of the snap fit connector 14 with the snaps being located on opposite sides of the plane a-a along the length of the snap fit connector 14. FIG. 7E shows a single snap 24 being present. Although shown in the figures with specific configurations, it is to be understood that the snaps can be presented in any possible configuration and are not limited to those shown in the Figures.

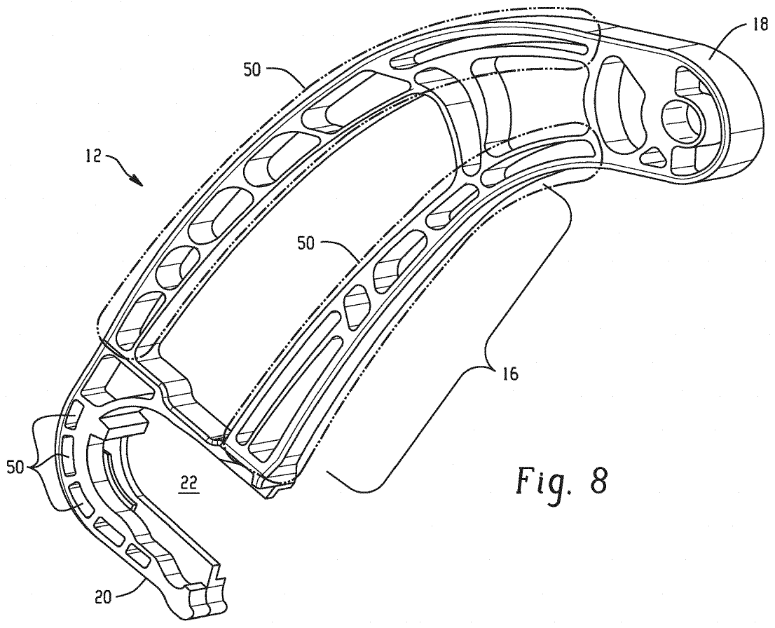

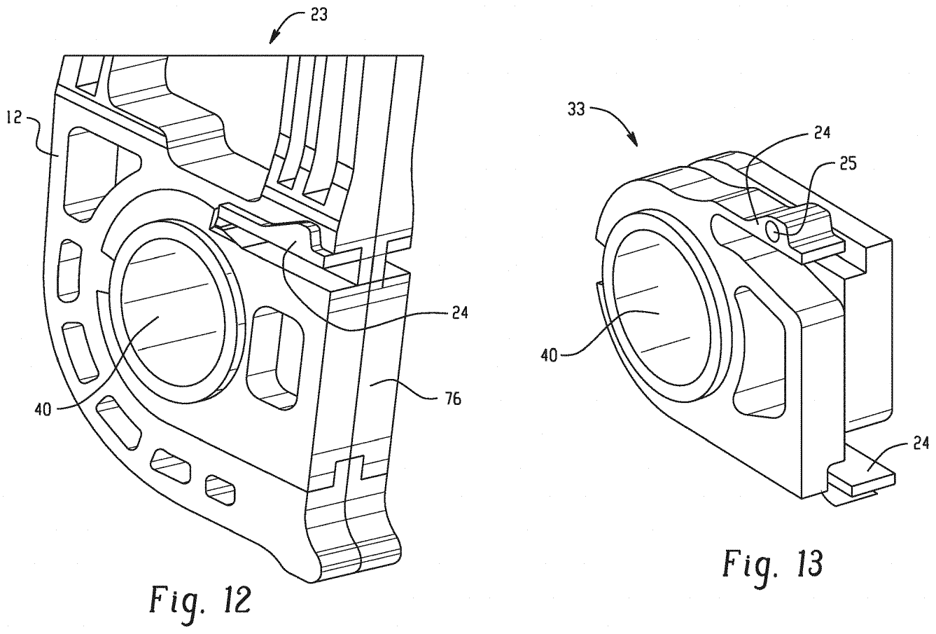

FIG. 8 is a detailed isometric view of the support arm 12. As shown in FIG. 12, the seat end 20 of the support arm 12 includes the opening 22 that is configured to accept the snap fit connector 14. In FIG. 8, multiple flanges 50 can be present along the body 16 of the support arm 12. The flanges 50 can improve load carrying capacity. This means that the flanges 50 can improve the structural capabilities of the support arm 12 to allow heavier loads before stress cracking or breakage of the support arm. The flanges 50 can help distribute the load across the entire body 16 of the support arm 12. Flanges can also optionally be present at the seat end 20 of the support arm 12 to further increase and improve upon the load bearing capacity of the support arm 12.

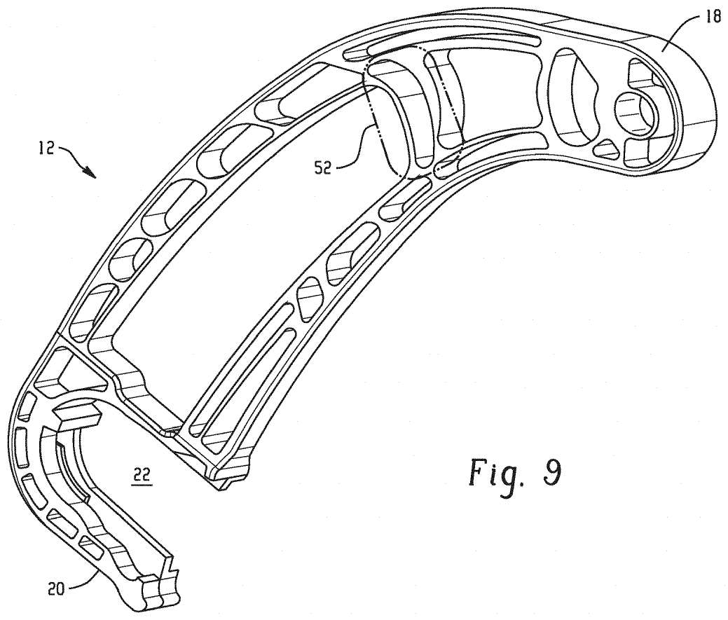

Turning now to FIG. 9, the support arm 12 of FIG. 8 is shown with the addition of ribs 52 in a curved region 53 of the body 16. The ribs 52 can increase structural rigidity of the support arm 12. The ribs 52 can provide additional structural enhancement to the tray table assembly 10 and support arm 12. The ribs 52 can have any configuration that will assist in achieving the desired mechanical properties of the support arm 12 and tray table 10. The ribs 52 can be disposed perpendicularly, at an angle, diagonally, or can have an “X” shape.

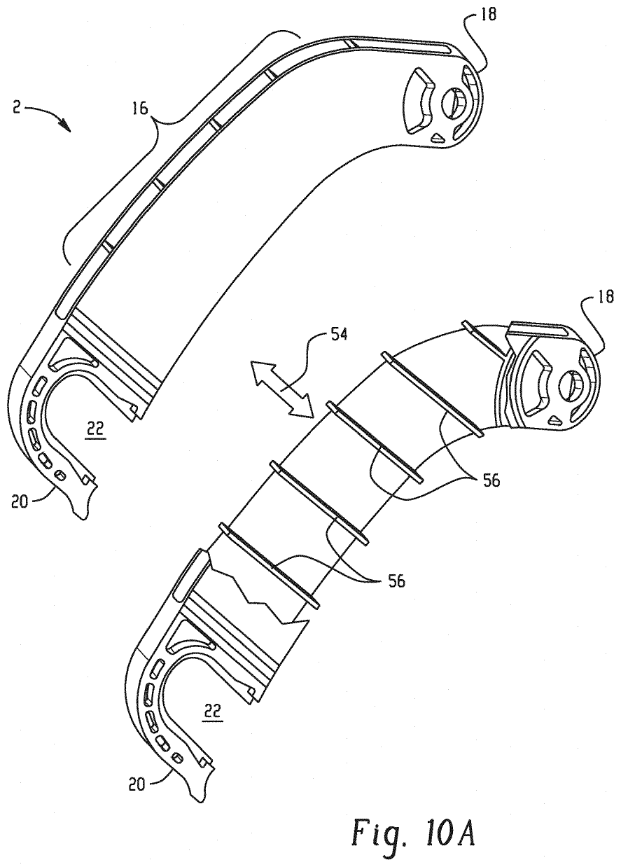

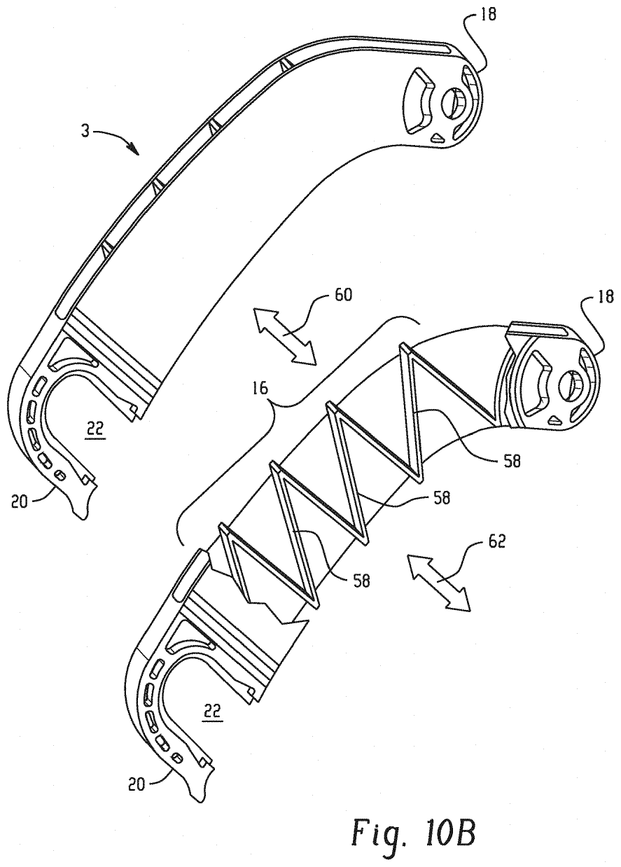

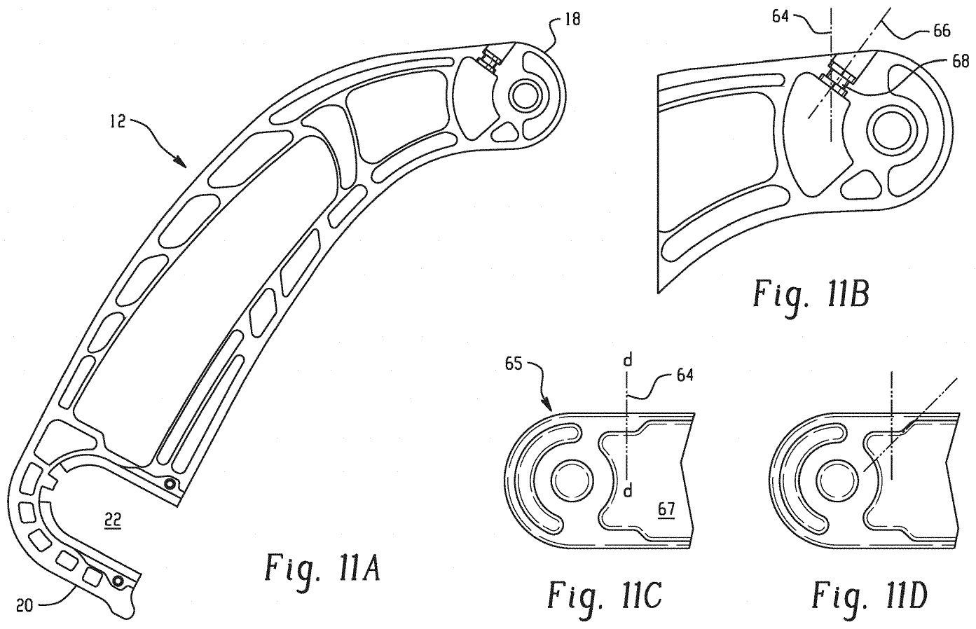

FIGS. 10A and 10B show additional configurations for support arms 2, 3 respectively with various designs in the body 16 of the support arm 12. For example, as shown in FIG. 10A, vertical ribs 56 can be present along the body 16 of the support arm 2. The vertical ribs 56 in FIG. 10A can be formed via a process with a single side core draw direction 54. FIG. 10B shows the support arm 3 with diagonal ribs 58 present along the body 16 of the support arm 3. The diagonal ribs 58 in FIG. 10B were formed using a process with two side cores. As showing in FIG. 10B, an open section of the support arm 3 has a first side core draw direction 60 and a second side core draw section 62 to make diagonal ribs 58 on the body 16 of the support arm 3.

Turning now to FIGS. 11A-11D, the table end 18 of the support arm 12 is shown in further detail. The support arm 12 can include an insert 65 therein as is shown FIG. 11C. The insert 65 can be located in the table end 18 of the support arm 12 with a set screw 68 (also referred to herein as a grub screw) configured to be positioned in the insert 65 along line d-d shown in FIG. 11C. The set screw 68 is used to regulate the position of the tray table 11. The location along line d-d is one of the most stressed regions on the support arm 12. The insert 65 can be configured to be any shape such that it fills at least a portion of a cavity 67 in the support arm 12. The insert 65 can be located in various positions of the table end 18 of the support arm 12. For example, the insert 65 can be located in one or more of the area around the pin or the pivot, at a location where the tray table arm changes direction (i.e. where the tray table arm curves), in the region of a maximum bending moment, and along the length of or in the regions of high compressive stress along an inner edge. The position and orientation of the set screw 68 can improve load transfer from the set screw 68 to the support arm 12. In a metal support arm, the set screw 68 is set at an angle of 90 degrees with the tray table top. It was surprisingly discovered that by changing the angle of the set screw to less than 90 degrees, for example, less than or equal to 45 degrees, the axial force experienced by the insert can be decreased. Changing of the angle as described herein can also increase the area over which a load is distributed thereby reducing overall stress in the support arm.

The insert 65 can comprise metal (such as aluminum, an aluminum alloy, brass, bronze, and steel), a foam (such as a polyurethane foam, a polyimide foam such as a polyetherimide foam for example ULTEM™ resin, a polystyrene foam such as STYROFOAM™, a silicone foam, or a polyvinyl chloride foam), a polymeric material different from that of the support arm, or the insert 65 can be a void space. The insert 65 can comprise the same material throughout the support arm 12 or can be made of different materials at different locations. For example, the insert 65 can comprise a higher modulus material than that of the polymeric material of the support arm 12 in the high stress regions (such as aluminum or a highly filled polymeric material) and can comprise a lower modulus material than that of the polymeric material of the support arm 12 in the low stress regions (such as a polyetherimide foam or simply a void space) to reduce the weight of said support arm 12.

Turning now to FIGS. 12 and 13, additional snap designs are shown. In FIG. 12, the snaps 24 are provided at the top on both the left and right sides of the snap fit connector 23 with a solid support 76 located between the top 80 and bottom 82 of a snap fit connector 23. FIG. 13 shows a top-bottom diagonally opposite design of a snap fit connector 33 where the snaps 24 are located at the top 80 and bottom 82 of the snap fit connector 33, but are located on opposite sides of the snap fit connector 14. The snap fit connectors 23, 33 can include an opening 40 configured to accept an assembly rod for assembly to the tray table 11.

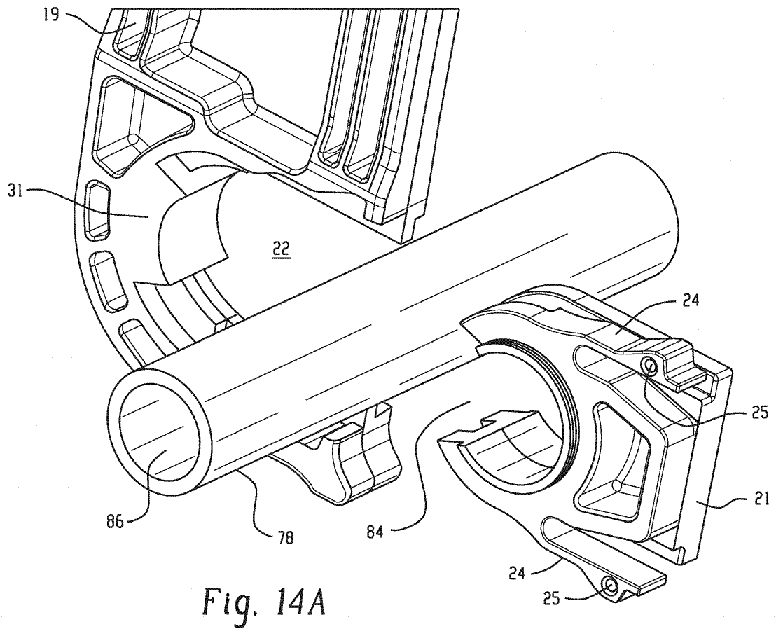

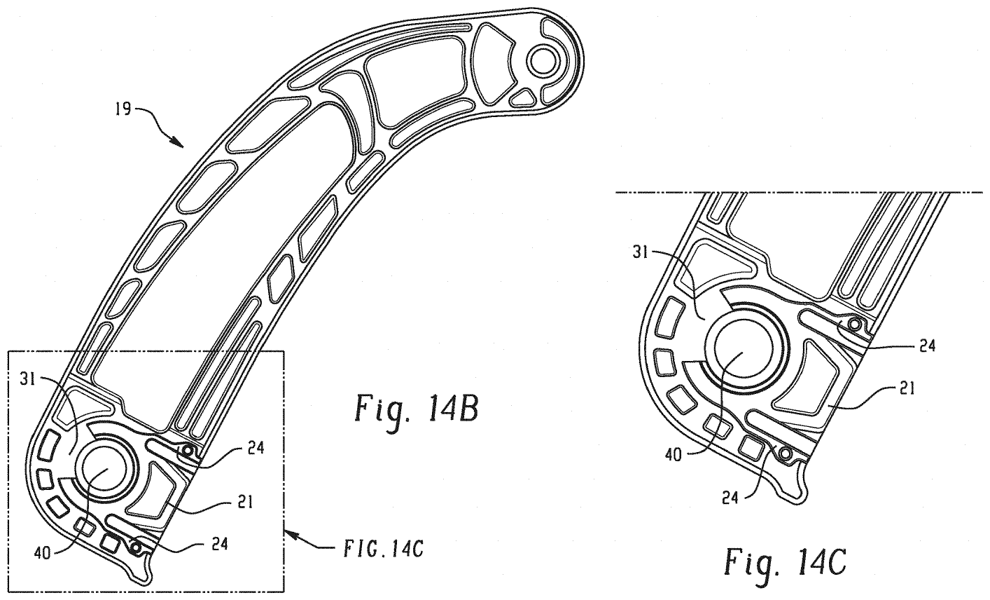

FIGS. 14A, 14B, and 14C show a double snap fit joint. As can be seen, the snap fit connector 21 can first be snap fit into an assembly rod 78, after which the snap fit connector 21 with the assembly rod 78 attached can be snap fit into the opening 22 of a support arm 19. FIG. 14A is an exploded view of the dissembled snap fit connector 21 with snaps 24 and holes 25 in snaps 24. The snap fit connector 21 contains a generally “C” shaped cross-section with the open section 84 of the C shaped cross-section directed toward the assembly rod 78. The open section 84 can be configured to accept the assembly rod 78. The assembly rod 78 can have a hollow cross-section 86 as demonstrated in the figures. Optionally, the assembly rod 78 can have a solid (e.g., filled) cross-section (not shown). The support arm 19 can contain a solid portion 31 extending from the opening 22 in the support arm configured to accept the assembly rod 78. The solid portion 31 of the support arm 19 along with the C shaped cross-section in the snap fit connector 21 can provide smooth rotation of the support arm and snap fit connect assembly around the rod 78. FIG. 14B shows the support arm 19 and the snap fit connector 21 connected to one another where the assembly rod 78 has been inserted into and is in mechanical communication with the solid portion 31 of the support arm 19. FIG. 14C is an exploded view of the boxed section 3 in FIG. 14B.

The support arm and/or snap fit connector can be formed via injection molding. The injection molding process can be a 1-shot or 2-shot injection molding process or can include injection compression molding. The injection molding process can use heat and cool technology, where a mold is rapidly heated and kept at that elevated temperature during the injection and packing phase of the polymeric material and subsequently cooled to the required mold temperature. This heat and cool technology process is beneficial as it surprisingly allows for the reduction, even as much as by a fraction of a millimeter in support arm thickness of the minimum thickness. Using this process, a minimum thickness of as little as 1 millimeter (mm) could be obtained depending upon the viscosity of the polymeric material. Additionally, this heat and cool process can also improve the knit line strength of the part, which can enhance the overall part structural performance.

For example, injection molding using heat and cool technology can involve rapidly heating the mold at a rate of 10 to 40 degrees centigrade per second (° C./sec), for example, 12 to 25° C./sec to greater than or equal to the glass transition temperature of the polymeric material. The mold can be heated to a temperature greater than or equal to 180° C., specifically greater than or equal to 200° C. Once the mold has reached its heated mold temperature, the polymeric material can be injected (filled) and packed into the mold. The polymeric material can be injected at a temperature of greater than or equal to the melt temperature of the materials. The polymeric material can be injected at a temperature of greater than or equal to 350° C., for example, greater than or equal to 390° C., for example, greater than or equal to 400° C. Subsequently, the mold can be cooled (e.g., rapidly cooled such as at a rate of 5 to 20° C./sec, for example, 10 to 12° C./sec). The mold can be cooled such that the polymeric material cools to a temperature of less than its ejection temperature. The polymeric material can then be ejected from the mold. The process can then be repeated for the production of a subsequent support arm.

The support arm can be over-molded in a two shot injection molding process, where after the first material is molded as described above, a second material can be molded over the first material. The second material can be added to enhance the geometric stiffness of the tray table arm in order to compensate for the lower stiffness of the polymeric as compared to metal tray table arms. Accordingly, the second material can be used to form the insert or can be used to fill in a reinforcing region. It is to be understood that the reinforcing region can take on various shapes, can be located on one or both sides of the flange, or can be located in a region or along the length of the tray table arm. The second material can be a foam as described for the insert or can be the same or different polymeric material as that of the support arm.

The support arms and connectors described herein can be formed through an additive manufacturing process. For example, a support arm and/or a connector can be formed through Material Extrusion, Fused Deposition Modeling (FDM) or Fused Filament Fabrication (FFF), Selective Laser Sintering (SLS), Direct Metal Laser Sintering (DMLS), Electron Beam Freeform Fabrication (EBF³), Electron Beam Melting (EBM), Laminated Object Manufacturing (LOM), Stereolithography (SLA), and Digital Light Processing (DLP).

Additive Manufacturing (AM) which is a production technology that makes three-dimensional (3D) solid objects of virtually any shape from a digital model. Generally, this is achieved by creating a digital blueprint of a desired solid object with computer-aided design (CAD) modeling software and then slicing that virtual blueprint into very small digital cross-sections. These cross-sections are formed or deposited in a sequential layering process in an AM machine to create the 3D object.

Metal tray table arms generally have a slot in the tray table end where a support pin moves during the opening/closing of the tray. A threaded screw can be located at least at one end of the slot in support arm to prevent the support pin from further rotating when the tray table is in its operable position. When the aluminum is exchanged with polymeric materials in tray table support arms, the high forces the support pin exerts on the threaded screw are transmitted to the polymeric material at the edges of the threads, which can result in crack initiation and propagation.

The use of a grub pin to eliminate the contact of the threaded screw with the polymeric material can be accomplished by positioning a grub in one or both of the stop locations for the stopper pin, where one or both of the grub pins can be insert molded into the support arm. The grub pin can have a threaded opening, through which the threaded screw can be inserted. The support arm can be designed such that the grub pin traverses through the support arm in a region of increased thickness. The grub pin can be made of metal, such as aluminum. As previously described herein the grub pin (i.e., set screw) can have an angle of less than 90 degrees, for example, less than or equal to 45 degrees.

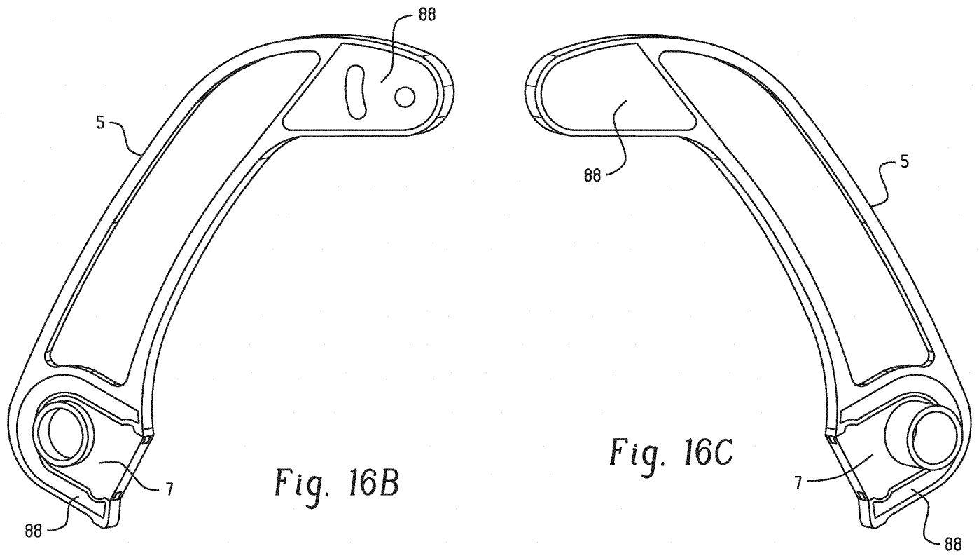

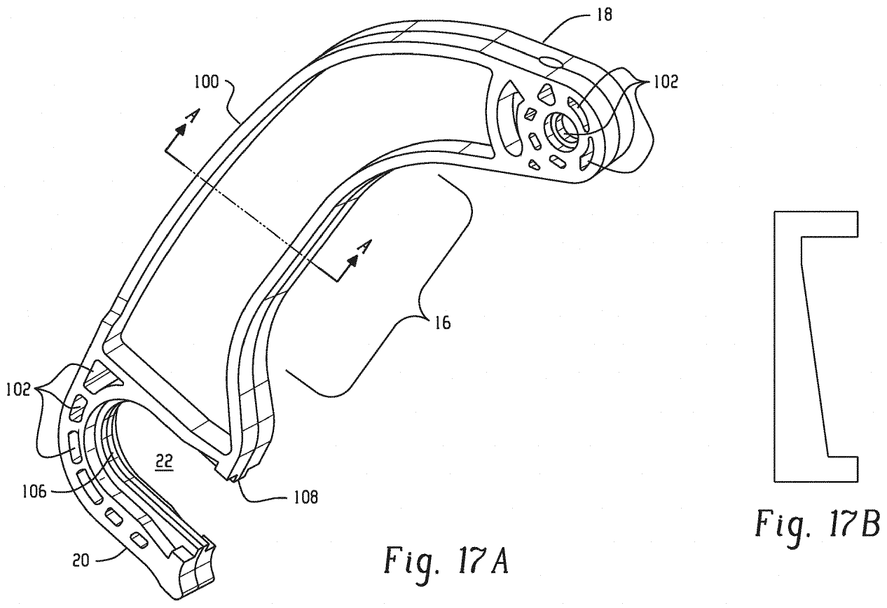

FIG. 16A illustrates another support arm 5 and clip in connector 7. The support arm 5 can include ribs 90 on the table end 18 and the seat end 20. Fascia 88 can be used in the support arms 5 to hide reinforcement ribbing while still allowing access to mounting features. The fascia can be made of a polymeric material or can be fabricated of stamped steel to supply an additional bearing surface for the load on mounting pins at the table end 18 of the support arm 5. The support arm 5 and clip in connector 7 can have a mating tongue and groove design. This tongue and groove design can assist in preventing the support arm 5 from sliding off the clip in connector 7, as well as keeping the support arm's 5 alignment. Half round bosses can optionally be added to the mating surfaces of the support arm 5. The clip in connector 7 allows for easy and quick removal of broken or damaged support arms. The clip in adaptor can also eliminate the use of an alignment screw for lateral alignment and retention, which can assist in ensuring maximum material for load transfer stop at the seat end 20 of the support arm. FIGS. 16B and 16C show a view of the assembled support arm 5 and clip in connector 7. Since the left and right support arms have a symmetric design, one tool can be used for both allowing for cost savings.

FIGS. 17A and 17B show another design of a support arm 100. In this design of the support arm 100, ribs 102 are located at the table end 18 and the seat end 20 with an opening 22 located in the seat end 20 configured to accept a snap fit connector. The support arm 100 includes a body portion 16 disposed between the table end 18 and the seat end 20. FIG. 17B is a cross-sectional view of the support arm 100 along line A-A in FIG. 17A. A channel 106 can be present in the opening 22 as well as an extension 108 extending from the opening 22 configured to engage with a snap fit connector.

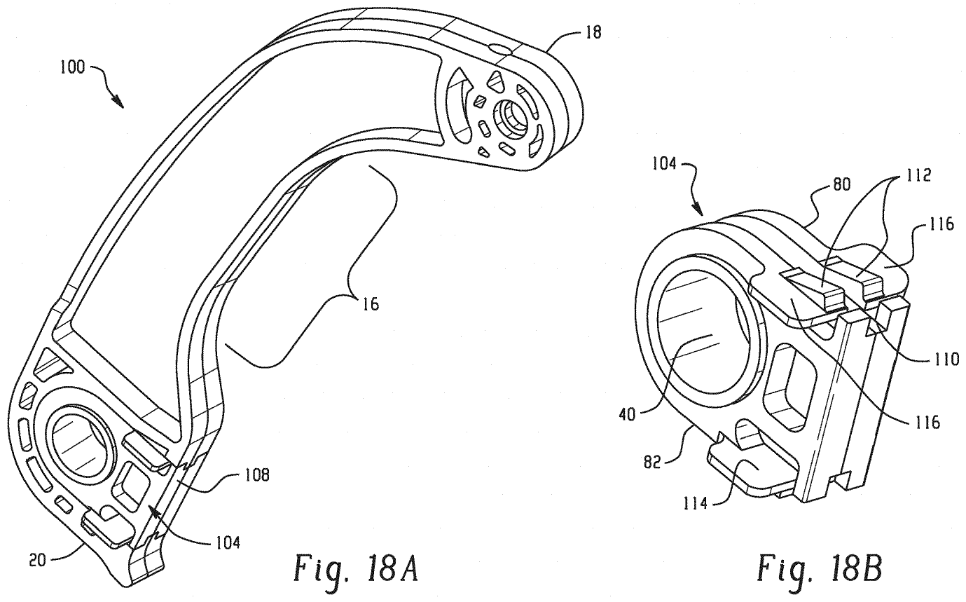

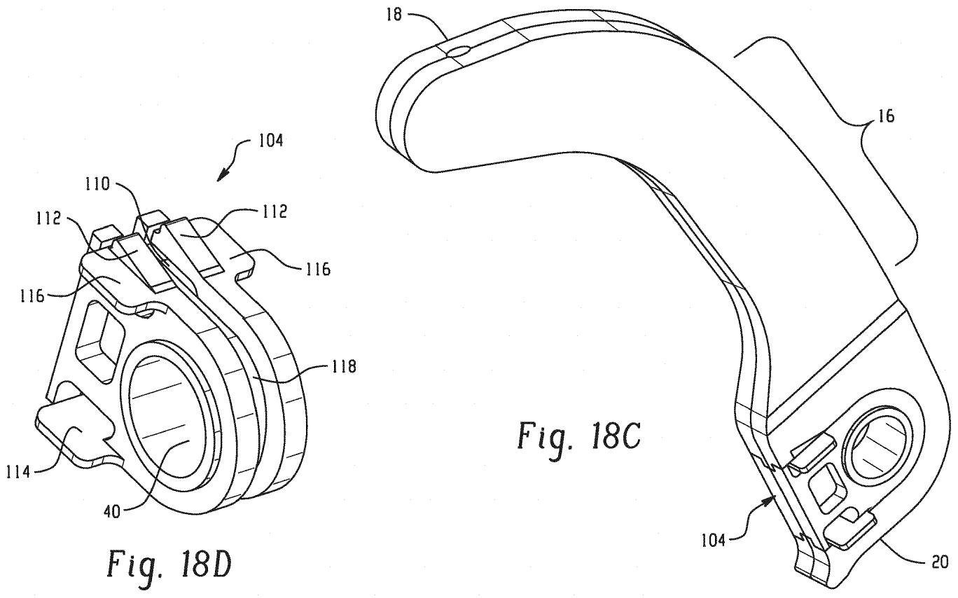

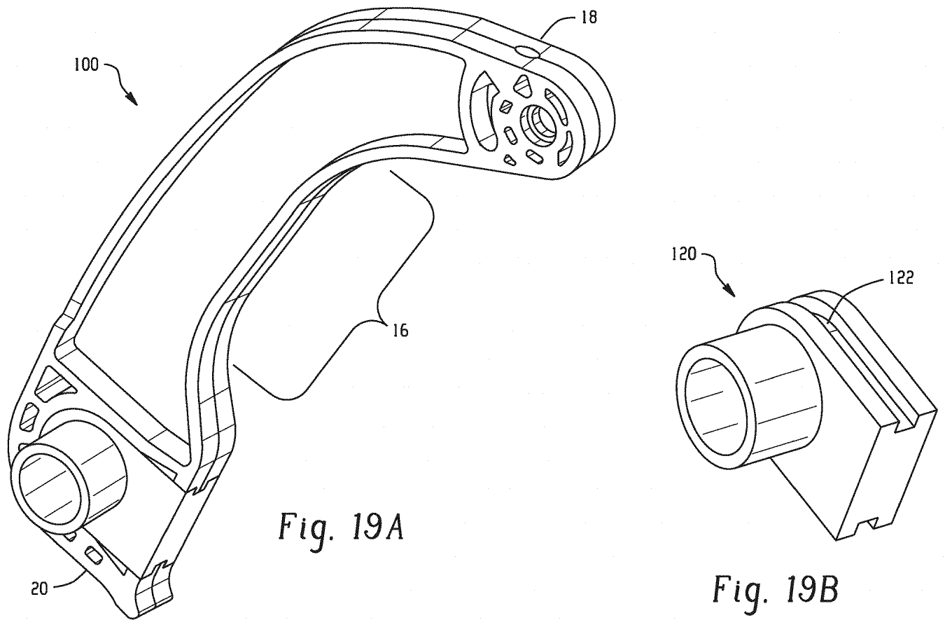

FIGS. 18A-18D show the support arm 100 and a snap fit connector 104. The snap fit connector 104 can include an indentation 110 configured to accept the extension 108 from the support arm 100. The snap fit connector 104 can include snaps 112 located at a top portion 80 of the snap fit connector 104. A platform 114 can be located at a bottom portion 82 of the snap fit connector 104. Once the snap fit connector 104 has been snapped into place it cannot be removed unless a user presses on ledge 116 in a downward motion to release the snap fit connector 104 from the support arm 100. A recess 118 can be present in the snap fit connector 104 configured to engage with the channel 106 of the support arm 102. FIGS. 19A and B illustrate the support arm 100 with a connector 120 configured to be attached thereto. A recess 122 can be present in the connector 120 configured to engage with the channel 106 of the support arm 102.

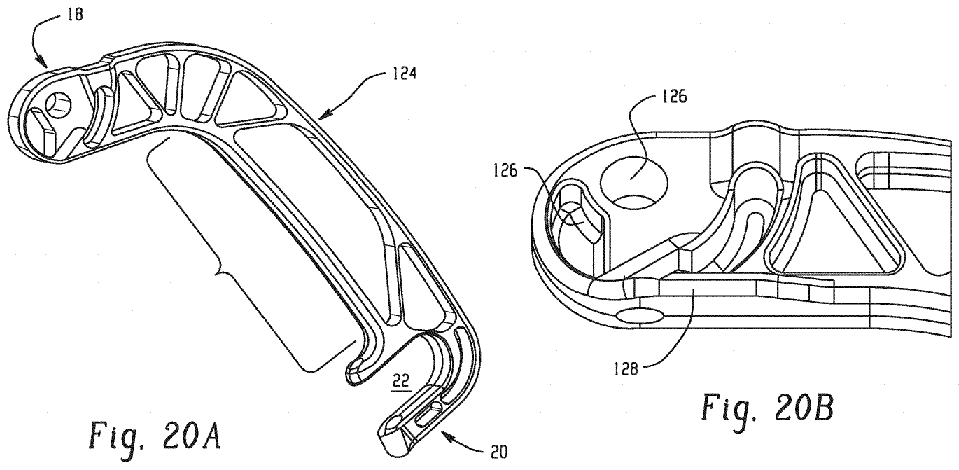

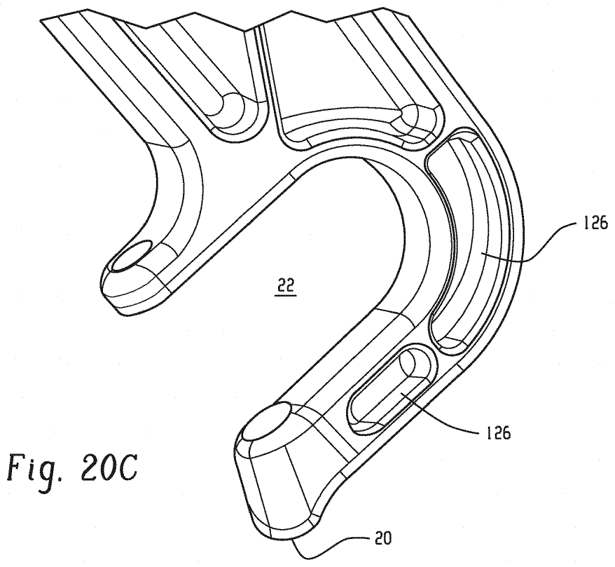

FIGS. 20A-20C show another design of a support arm 124 having a table end 18, a seat end 20, and a body 16 disposed therebetween. As seen in FIG. 20B, the support arm 124 can include regions with cored-out material 126 and regions with raised material 128. The cored-out material region 126 can adjusted to the pin location and to maintain the wall and minimize voids in the support arm 120. FIG. 20C is a close-up view of the seat end 20 of the support arm 124 showing further cored-out regions 126.

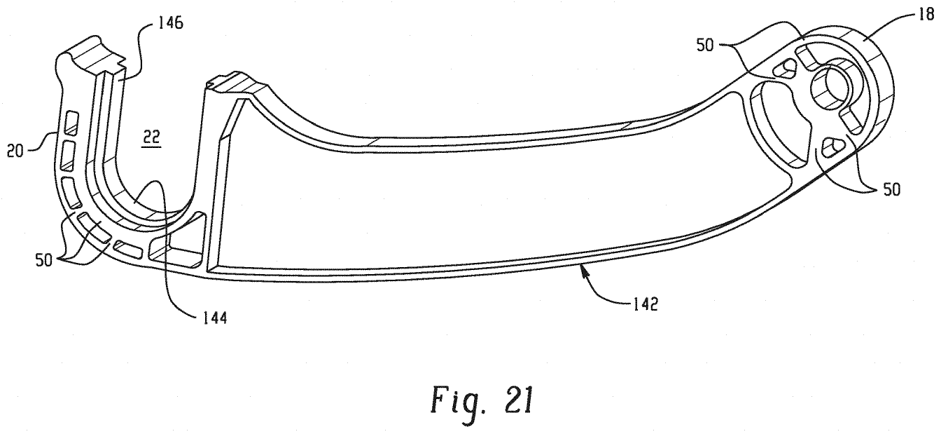

FIG. 21 shows a support arm and connector assembly. For example, the support arm 142 can contain flanges 50 located at the table end 18 and the seat end 20 with an opening 22 in the seat end 20. The opening 22 in the seat end can 20 contain a curved portion 144 and a raised portion 146 configured to accept corresponding mating pieces on a snap fit connector to be attached thereto. Any of the snap fit connectors described and shown herein can be adjusted to fit within the opening 22 of the support arm 142.

The following examples are provided as non-limiting examples of the present disclosure.

### EXAMPLES

### Example 1

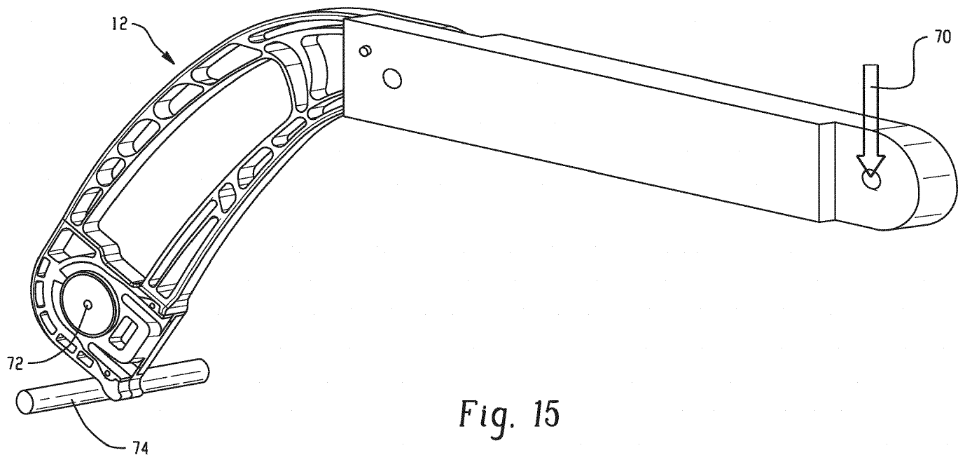

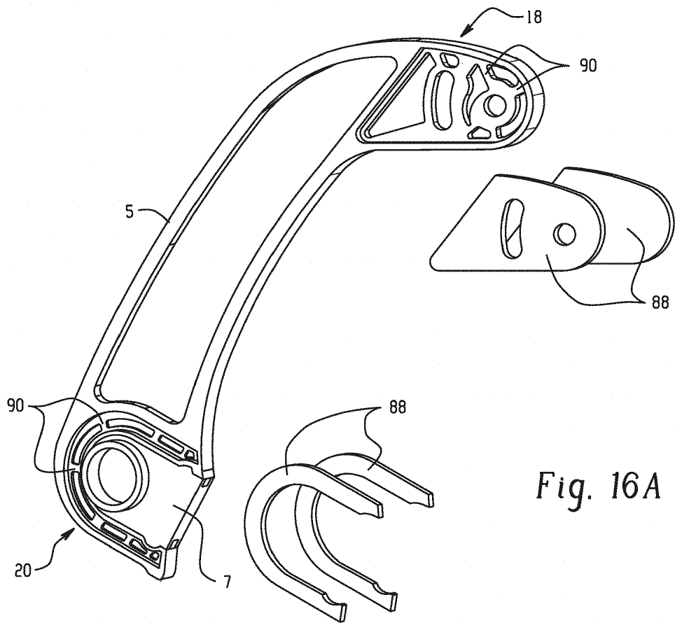

In this example, finite element analysis (FEA) is done to evaluate the structural performance of the support arm. The arm is kept in a virtual test fixture as shown in FIG. 15. The test fixture emulates actual use of the arm in an aircraft seating system. The free end of the extension rod is subjected to a vertically downward load 70 with the arm being free to rotate about the axis of the hole 72 but restrained through the support pin 74. Polyetherimide resin which is 20% carbon fiber filled is used, i.e., ULTEM™, commercially available from SABIC's Innovative Plastics business. The material used for the snap fit connector is unfilled polyetherimide resin, i.e., ULTEM™, commercially available from SABIC's Innovative Plastics business. Based on different aircraft manufacturers, each of the arms should take a minimum load of 75 pounds (34 kilograms (kg)) applied at the end of the extension rod before any failure. In the design shown in FIG. 15, the support arm could take a load of about 100 pounds (about 45.3 kg) before any failure of the arm or snap fit connector occurs.

### Example 2

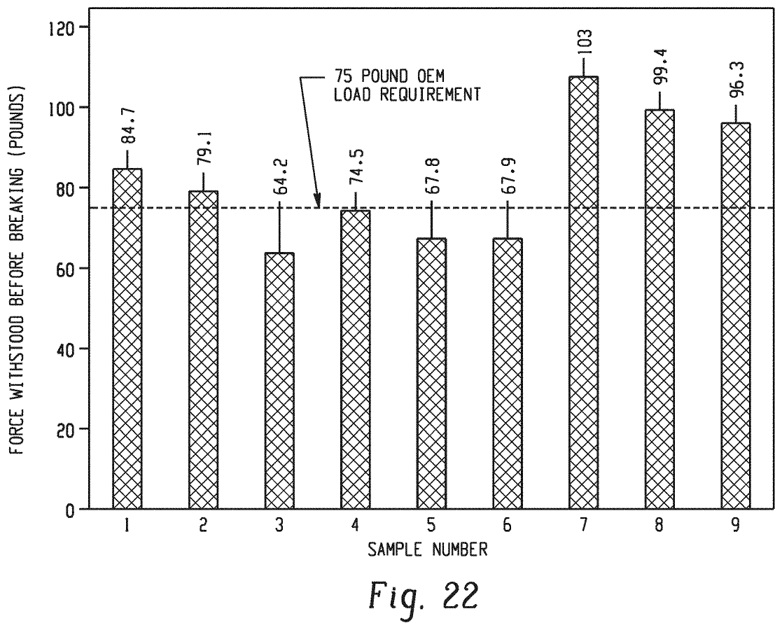

In this example, various support arms with the design shown in FIG. 22 were tested with varying material configurations as shown in Table 1. Materials with varying carbon fiber content were test. Materials with varying viscosities were also tested.

TABLE 1
Material Configurations for Support Arm

| Sample No. | Material Description |
|---|---|
| 1 | LNP ™ THERMOCOMP ™ EC004APQ, polyetherimide |
| | with 20 wt. % carbon fiber, easy flow, low viscosity |
| 2 | LNP ™ THERMOCOMP ™ EC004PXQ, polyetherimide |
| | with 20 wt. % carbon fiber, high viscosity |
| 3 | LNP ™ THERMOCOMP ™ EC006APQ, polyetherimide |
| | with 30 wt. % carbon fiber, easy flow, low viscosity |
| 4 | LNP ™ THERMOCOMP ™ EC006PXQ, polyetherimide |
| | with 30 wt. % carbon fiber, high viscosity |
| 5 | LNP ™ THERMOCOMP ™ EC008APQ, polyetherimide |
| | with 40 wt. % carbon fiber, easy flow, low viscosity |
| 6 | LNP ™ THERMOCOMP ™ EC008PXQ, polyetherimide |
| | with 40 wt. % carbon fiber, high viscosity |
| 7 | LNP ™ THERMOCOMP ™ LC006EXQ, PEEK with |
| | 30 wt. % carbon fiber |
| 8 | LNP ™ THERMOCOMP ™ LC008EXQ, PEEK with |
| | 40 wt. % carbon fiber |
| 9 | LNP ™ THERMOCOMP ™ LCAPXQ, PEEK with |
| | 40 wt. % carbon fiber |

After testing was noted that the materials used for Samples 1 and 2 were able to withstand and exceed the 75-pound load requirement. Samples 3, 4, 5, and 6, failed the requirement, as all failed before a 75-pound load was applied. Samples 7, 8, and 9 also show acceptable load carrying capacities. The results are shown in FIG. 22.

The support arms, snap-fit connectors, tray table assemblies, methods of making thereof, and methods of attachment disclosed herein include at least the following Aspects:

Aspect 1: A support arm, comprising: a body portion disposed between a seat end and a table end; wherein the support arm comprises a composition comprising a polymeric material, a metallic material, a thermoset material, an elastomeric material, or a combination comprising at least one of the foregoing and a filler; and wherein the seat end comprises a snap fit connector configured to engage with an opening in the seat end.

Aspect 2: The support arm of Aspect 1, wherein the opening comprises a gear tooth configured to engage with a corresponding recess in the snap fit connector.

Aspect 3: The support arm of any of the preceding aspects, wherein the snap fit connector comprises snap features on a top portion and a bottom portion of the snap fit connector or wherein the snap fit connector comprises snap features on a left portion and a right portion in the top portion and/or the bottom portion of the snap fit connector.

Aspect 4: The support arm of Aspect 3, wherein the snap features located on the top portion and the bottom portion of the snap fit connector are located on opposite sides of the connector or are located on the same side of the connector.

Aspect 5: The support arm of Aspect 4, wherein the snap features comprise half a width of the snap-fit connector.

Aspect 6: The support arm of any of the preceding aspects, wherein half a width of the snap-fit connector comprises a solid portion configured to transfer a load applied to the body portion of the support arm.

Aspect 7: The support arm of any of the preceding aspects, wherein the snap fit connector comprises disassembly openings on each of the snap features configured to accept a tool to effect disassembly from the body portion.

Aspect 8: The support arm of any of the preceding aspects, wherein the body portion comprises flanges dispersed along a length of the body portion, wherein the flanges are located along outside edges of the body portion.

Aspect 9: The support arm of any of the preceding aspects, wherein the body portion comprises a curved portion near the table end of the support arm, wherein ribs are dispersed in the curved portion.

Aspect 10: The support arm of Aspect 9, wherein the body portion comprises vertical ribs or wherein the body portion comprises diagonal ribs.

Aspect 11: The support arm of any of the preceding aspects, wherein the table end comprises an insert located in a high stress region of the support arm.

Aspect 12: The support arm of Aspect 11, further comprising a set screw located in the insert.

Aspect 13: The support arm of Aspect 12, wherein the set screw is disposed at an angle less of than 90 degrees with respect to a tray table attached to the support arm, preferably wherein the angle is less than or equal to 45 degrees.

Aspect 14: The support arm of any of the preceding aspects, wherein the polymeric material comprises polycarbonate, polyester, a polyamide, a polyimide, a polyketone, a polysulfide, a polysulfone, a polyacrylate, a polyacetal, a polyacetate, a fluoro plastic, a chloro plastic, a polyethylene, a polyurethane, polypropylene, an acrylonitrile butadiene styrene copolymer, a styrene acrylonitrile copolymer, polyphenylene, polyvinyl alcohol, polystyrene, polycaprolactone, polybutylene, polybutadiene, a copolymer comprising at least one or more of the foregoing, or a blend comprising at least one or more of the foregoing, preferably wherein the polymeric material comprises polyetherimide.

Aspect 15: The support arm of any of the preceding aspects, wherein the filler is present in an amount of less than or equal to 80 weight %, based on the total weight of the composition of the support arm, preferably wherein the filler is present is an amount of less than or equal to 20 weight %.

Aspect 16: The support arm of any of the preceding aspects, wherein the snap fit connector comprises a polymeric material.

Aspect 17: A method of attaching a snap fit connector to a support arm, comprising: snap fitting an assembly rod into a snap fit connector; and snap fitting the snap fit connector to support arm of any of the preceding Aspects.

Aspect 18: A tray table, comprising: a support arm comprising a body portion disposed between a seat end and a table end, wherein the support arm comprises a composition comprising a polymeric material a metallic material, a thermoset material, an elastomeric material, or a combination comprising at least one of the foregoing and a filler, and wherein the seat end comprises a snap fit connector configured to engage with an opening in the seat end; a torque rod; a pivot block; a stopper pin; a table; and a means for keeping the tray table in the operable position.

Aspect 19: The tray table of Aspect 18, wherein the means for operable position comprises a set screw disposed in an insert at the table end of the support arm; wherein the set screw prevents the further rotational motion of the stopper pin when the tray table is in the operable position.

Aspect 20: The tray table of Aspect 19, wherein the set screw is disposed at an angle of less than 90 degrees with respect to a tray table attached to the support arm, preferably wherein the angle is less than or equal to 45 degrees.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference. While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A support arm, comprising:
a body portion disposed between a seat end and a table end;
wherein the support arm comprises a composition comprising a polymeric material, a metallic material, a thermoset material, an elastomeric material, or a combination comprising at least one of the foregoing, and a filler; and
wherein the seat end comprises a snap fit connector configured to engage with an opening in the seat end;
the body portion comprises flanges dispersed along a length of the body portion, wherein the flanges are located along outside edges of the body portion, at the seat end and at the table end of the support arm;
the body portion comprises a curved portion near the table end of the support arm, where ribs are dispersed in the curved portion and extend between the flanges; and
the seat end and/or the table end include cored-out material regions forming weight-reducing voids in the support arm.

2. The support arm of claim 1, wherein the opening comprises a gear tooth configured to engage with a corresponding recess in the snap fit connector.

3. The support arm of claim 1, wherein the snap fit connector comprises snap features on a top portion and a bottom portion of the snap fit connector or wherein the snap fit connector comprises snap features on a left portion and a right portion in the top portion and/or the bottom portion of the snap fit connector.

4. The support arm of claim 3, wherein the snap features located on the top portion and the bottom portion of the snap fit connector are located on opposite sides of the connector or are located on the same side of the connector.

5. The support arm of claim 4, wherein the snap features comprise half a width of the snap-fit connector.

6. The support arm of claim 5, wherein half a width of the snap-fit connector comprises a solid portion configured to transfer a load applied to the body portion of the support arm.

7. The support arm of claim 6, wherein the snap fit connector comprises disassembly openings on each of the snap features configured to accept a tool to effect disassembly from the body portion.

8. (canceled)

9. (canceled)

10. The support arm of claim 1, wherein the body portion comprises vertical ribs or wherein the body portion comprises diagonal ribs.

11. The support arm of claim 10, wherein the table end comprises an insert located in a high stress region of the support arm.

12. The support arm of claim 11, further comprising a set screw located in the insert.

13. The support arm of claim 12, wherein the set screw is disposed at an angle less of than 90 degrees with respect to a tray table attached to the support arm.

14. The support arm of claim 1, wherein the polymeric material comprises polycarbonate, polyester, a polyamide, a polyimide, a polyketone, a polysulfide, a polysulfone, a polyacrylate, a polyacetal, a polyacetate, a fluoro plastic, a chloro plastic, a polyethylene, a polyurethane, polypropylene, an acrylonitrile butadiene styrene copolymer, a styrene acrylonitrile copolymer, polyphenylene, polyvinyl alcohol, polystyrene, polycaprolactone, polybutylene, polybutadiene, a copolymer comprising at least one or more of the foregoing, or a blend comprising at least one or more of the foregoing.

15. The support arm of claim 14, wherein the filler is present in an amount of less than or equal to 80 weight %, based on the total weight of the composition of the support arm.

16. The support arm of claim 15, wherein the snap fit connector comprises a polymeric material.

17. A method of attaching the snap fit connector to the support arm of claim 1, comprising:
snap fitting an assembly rod into the snap fit connector, and
snap fitting the snap fit connector to the support arm.

18. A tray table, comprising:
the support arm of claim 1;
a tray table supported by the table end of the support arm; and
a set screw disposed in an insert at the tray table end of the support arm,
wherein the set screw assists with movement of the tray table from resting to operable positions.

19. (canceled)

20. The tray table of claim 18, wherein the set screw is disposed at an angle of less than 90 degrees with respect to a top of the tray table attached to the support arm.

21. The support arm of claim 1, wherein ribs in the curved portion of the body portion are curved.

22. A support arm, comprising:
a body portion disposed between a seat end and a table end;
wherein the support arm comprises a composition comprising a polymeric material, a metallic material, a thermoset material, an elastomeric material, or a combination comprising at least one of the foregoing, and a filler; and
wherein:
the seat end comprises a snap fit connector configured to engage with an opening in the seat end;
the body portion comprises flanges dispersed along a length of the body portion, wherein the flanges are located along outside edges of the body portion;
the body portion comprises a curved portion near the table end of the support arm, wherein ribs are dispersed in the curved portion, adjacent one-another, and extend between the flanges; and
at least one of the ribs forms an arcuate profile between the flanges.

23. A support arm, comprising:
a body portion disposed between a seat end and a table end;
wherein the support arm comprises a composition comprising a polymeric material, a metallic material, a thermoset material, an elastomeric material, or a combination comprising at least one of the foregoing, and a filler; and
wherein:
the seat end comprises a snap fit connector configured to engage with an opening in the seat end;
the body portion comprises flanges dispersed along a length of the body portion, wherein the flanges are located along outside edges of the body portion;
the body portion comprises a discrete curved portion near the table end of the support arm, wherein ribs are dispersed only in the curved portion, adjacent one-another, and extend between the flanges; and
at least one of the ribs forms an arcuate profile between the flanges.
